(19) United States
(12) Patent Application Publication
(10) Pub. No.: US 2024/0289466 A1
(43) Pub. Date: Aug. 29, 2024

(54) MEMORY INTEGRITY VERIFICATION BY AN ENERGY PROCESSING UNIT

(71) Applicant: Meta Platforms Technologies, LLC, Menlo Park, CA (US)

(72) Inventors: Wojciech Stefan Powiertowski, Kirkland, WA (US); Avdhesh Chhodavdia, Fremont, CA (US); Gregory Edward Ehmann, Sleepy Hollow, IL (US); Nagendra Gupta Modadugu, San Francisco, CA (US); Sudhir Satpathy, Redmond, WA (US)

(21) Appl. No.: 18/175,358

(22) Filed: Feb. 27, 2023

(51) Int. Cl. G06F 21/60; G06F 21/55; G06F 21/79

(52) U.S. Cl. CPC G06F 21/602; G06F 21/556; G06F 21/79

(57) ABSTRACT

In one embodiment, a method by an Energy processing Unit (EPU) of a computing system includes detecting an event that triggers an integrity verification on a block of the local memory, determining that a hash for the block of the local memory is available, causing data corresponding to the block of the local memory to be read from a source location in response to the determination, performing an in-line hash operation on the data corresponding to the block of the local memory, and comparing an output of the in-line hash operation and a known hash for the block of the local memory.

### TECHNICAL FIELD

This disclosure generally relates to computing hardware systems, and in particular, related to verifying memory integrity in efficient manners.

### BACKGROUND

An Energy Processing Unit (EPU) is one of the pervasive components used in many System on a Chip (SoC) systems. The EPU may perform automated control of local clocks and the power state of both logic and memories. Functions of the EPU may include changing a state of a hardware component between OFF/ON/STANDBY/IDLE/RETENTION. The controls may be achieved through a programmable finite state machine (FSM) which can be configured to autonomously react to input from the cores and auxiliary hardware components.

A root of trust (RoT) may be an unconditionally trusted component of a device consisting of a computing engine and software that performs fundamental security service such as measurement, storage, integrity, verification, reporting, or updating. The RoT may be a security foundation for an SoC, other semiconductor device or electronic system. The ROT may contain keys used for cryptographic functions and enables a secure boot process. The ROT may be a stand-alone security module or implemented as security module within a processor or an SoC. In legacy systems, the RoT may verify the integrity of a memory during a power state transition of the memory into ON mode.

### SUMMARY OF PARTICULAR EMBODIMENTS

Particular embodiments described herein relate to systems and methods for verifying memory integrity at an EPU of a computing system. In particular embodiments, the computing system may be a System on a Chip (SoC) system. In particular embodiments, the system may need to verify the local memory integrity periodically or during a local memory state transition from RETENTION mode into ON mode. In particular embodiments, the system may offload content of the local memory to an external memory to switch the state of the local memory into OFF mode to save power. When the state of the local memory turns back into ON mode, an integrity verification on the content of the local memory may need to be performed while the content of the local memory is restored back into the local memory from the external memory. To perform the integrity verification of critical firmware and/or data in legacy systems, an RoT core needs to wake up, and the content of the firmware and/or the data need to be transferred into RoT local memory for a hash operation to be performed on the content of the firmware and/or the data to confirm the state of the firmware and/or data. Performing the integrity verification in this manner may incur increased power consumption and latency due to the state transition of the ROT core and the data movements. The systems and methods disclosed herein may allow the computing system to reduce the power consumption by allowing an EPU to perform the memory integrity verifications without waking the RoT up.

In particular embodiments, a computing system may comprise an EPU. The EPU comprises Control and Status Registers (CSRs), a hash core, and an EPU core. The EPU may detect an event that triggers an integrity verification on a block of the local memory. In particular embodiments, the local memory may be static random-access memory (SRAM). The EPU may determine that a hash for the block of the local memory is available. The CSRs may be programmed by an RoT core to maintain configuration information associated with an in-line hash operation on the block of the local memory. The configuration information associated with the in-line hash operation may comprise a base address of the block of the local memory and a size of the block, a source address for the source location, a key or a nonce to be used for the in-line hash operation, the known hash for the block of the local memory, and configurations that define the event. The EPU core may manage Finite State Machines (FSMs) for hardware components of the computing system including the local memory. The CSRs may provide the configuration information associated with the in-line hash operation including the known hash for the block of the local memory to the EPU core. In response to the determination that a hash for the block of the local memory is available, the EPU core may cause data corresponding to the block of the local memory to be read from a source location based on the configuration information associated with the in-line hash operation. In particular embodiments, the CSRs may provide the key or the nonce to the hash core. The hash core of the EPU may perform an in-line hash operation on the data corresponding to the block of the local memory with the key or the nonce. The EPU core of the EPU may compare an output of the in-line hash operation and a known hash for the block of the local memory.

In particular embodiments, the EPU core may determine that the output of the in-line hash operation is identical to the known hash for the block of the local memory. In response to the determination, the EPU core may release a soft-reset to wake up a processing unit associated with the local memory. In particular embodiments, the processing unit may be a processor core. In particular embodiments, the processing unit may be a microcontroller unit (MCU).

In particular embodiments, the EPU core may determine that the output of the in-line hash operation is not identical to the known hash for the block of the local memory. In response to the determination, the EPU core may trigger an error interrupt request (IRQ) to a security subsystem while keep the processing unit in reset.

In particular embodiments, the event may cause the state of the local memory from RETENTION mode into ON mode. An example of such an event may comprise receiving an interrupt. The source location is the block of the local memory. The EPU may discard the data after performing the in-line hash operation.

In particular embodiments, the event may cause the state of the local memory from OFF mode into ON mode. The EPU may determine whether the data corresponding to the block of the local memory needs to be restored from the location in the DRAM memory. The source location may be a location in an external memory such as a Quantum Random Memory Access (QRAM), a Direct Random Memory Access (DRAM) memory space, a memory mapped non-volatile storage device, or any suitable external memory. In particular embodiments, the source location may be a location in an always-ON region inside the computing system. The EPU may cause the data corresponding to the block of the local memory to be restored into the block of the local memory after the in-line hash operation on the data is performed.

In particular embodiments, the EPU may determine that the state of the local memory needs to move into OFF mode. The EPU may cause second data to be read from a second block of the local memory. The EPU may perform a second in-line hash operation on the second data. When a nonce is used for the second in-line hash operation, Linear Feedback Shift Registers (LFSR) seeded by the RoT may generate a nonce used for the second in-line hash operation. The LFSR may generate a different nonce for every hash operation on a block of data. With that, a block of data may generate different signatures when the block of data is hashed multiple times. Different signatures may provide protection against replay attacks, where stale data is provided by an attacker from the external memory using an old nonce. The EPU may store an output of the second in-line hash operation as a known hash for the second block of the local memory. The EPU may cause the second data to be written into a second source location in an external memory.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example logical architecture of an EPU for a memory integrity verification.

FIG. 2 illustrates an example flow for a memory integrity verification when a state of a local memory changes from RETENTION mode to ON mode.

FIG. 3 illustrates an example flow for a data restoration with an integrity verification when a state of a local memory changes from OFF mode to ON mode.

FIG. 4 illustrates an example flow for dynamically offloading data corresponding to a block of a local memory when a power state of the local memory switches from ON mode to OFF mode.

FIG. 5 illustrates an example method for verifying integrity of a local memory by an EPU.

FIG. 6 illustrates an example computer system.

### DESCRIPTION OF EXAMPLE EMBODIMENTS

In particular embodiments, an EPU of a computing system may verify memory integrity in an efficient manner to reduce power consumption of the computing system and to reduce the latency of the computing system. In particular embodiments, the computing system may be a System on a Chip (SoC) system. In particular embodiments, the system may need to verify the local memory integrity periodically or during a local memory state transition from RETENTION mode into ON mode. In particular embodiments, the system may offload content of the local memory to an external memory to switch the state of the local memory into OFF mode to save power. When the state of the local memory turns back into ON mode, an integrity verification on the content of the local memory may need to be performed while the content of the local memory is restored back into the local memory from the external memory. To perform the integrity verification of critical firmware and/or data in legacy systems, an RoT core needs to wake up, and the content of the firmware and/or the data need to be transferred into ROT local memory for a hash operation to be performed on the content of the firmware and/or the data to confirm the state of the firmware and/or data. Performing the integrity verification in this manner may incur increased power consumption and latency due to the state transition of the ROT core and the data movements. The systems and methods disclosed herein may allow the computing system to reduce the power consumption by allowing an EPU to perform the memory integrity verifications without waking the RoT up.

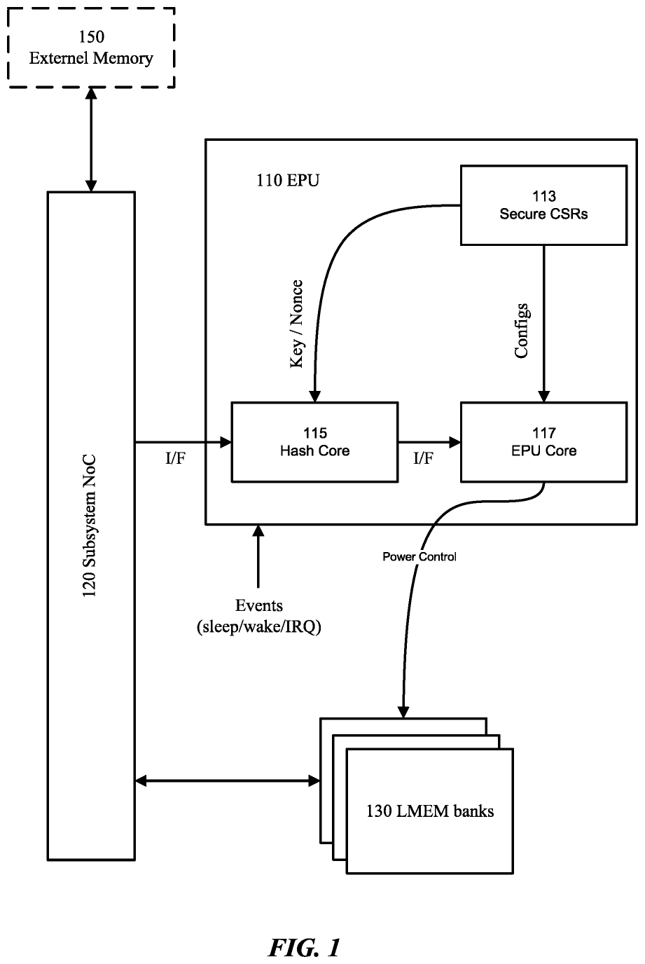

In particular embodiments, a computing system may comprise an EPU. The EPU comprises Control and Status Registers (CSRs), a hash core, and an EPU core. FIG. 1 illustrates an example logical architecture of an EPU for a memory integrity verification. As illustrated in FIG. 1, an EPU 110 of the computing system may comprise secure CSRs 113, a hash core 115, and an EPU core 117. In particular embodiments, the computing system may be an SoC system. The EPU 110 may detect an event and perform power control based on the detected event. The event may comprise sleep, wake, or an interrupt. The EPU 110 may have an interface to one or more subsystem network-on-chips (NoCs) 120. The subsystem NoC 120 may be connected to local memory 130 and one or more external memories 150. Although this disclosure describes a particular logical architecture of an EPU, this disclosure contemplates any suitable logical architecture of an EPU.

In particular embodiments, the EPU 110 may detect an event that triggers an integrity verification on a block of the local memory 130. The event may be a wake, an interrupt from a watchdog or timer block, or an on-demand request. Thus, the integrity verification on a block of the local memory may be triggered during a power state transition into ON mode, on demand, or periodically (triggered by an interrupt from a watchdog or timer block. In particular embodiments, the local memory may be static random-access memory (SRAM). The EPU 110 may determine that a hash for the block of the local memory 130 is available. The EPU core 117 may determine that a hash for the block of the local memory 130 is available based on configuration information for the secure CSRs 113. Although this disclosure describes the EPU determining that an integrity verification on a block of the local memory needs to be performed in a particular manner, this disclosure contemplates the EPU determining that an integrity verification on a block of the local memory needs to be performed in any suitable manner.

In particular embodiments, the secure CSRs 113 may be programmed by an RoT core to maintain configuration information associated with an in-line hash operation on the block of the local memory 130. The configuration information associated with the in-line hash operation may comprise a base address of the block of the local memory and a size of the block, a source address for the source location, a key or a nonce to be used for the in-line hash operation, a selection of a hash algorithm to be used, the known hash for the block of the local memory, and configurations that define the event. Although this disclosure describes a particular secure CSRs, this disclosure contemplates any suitable secure CSRs.

In particular embodiments, the EPU core 117 may manage Finite State Machines (FSMs) for hardware components of the computing system including the local memory 130. The CSRs 113 may provide the EPU core 117 the configuration information associated with the in-line hash operation including the known hash for the block of the local memory 130. In particular embodiments, after determining that a hash for the block of the local memory 130 is available, the EPU core 117 may cause data corresponding to the block of the local memory 130 to be read from a source location based on the base address of the block of the local memory 130, the size of the block, and the source address for the source location in the configuration information associated with the in-line hash operation. Although this disclosure describes causing data corresponding to the block of the local memory to be read from a source location in a particular manner, this disclosure contemplates causing data corresponding to the block of the local memory to be read from a source location in any suitable manner.

In particular embodiments, the hash core 115 of the EPU 110 may perform an in-line hash operation on the data corresponding to the block of the local memory 130 while the data stream flows through the interface from the subsystem NoC 120 to the EPU core 117. In particular embodiments, the CSRs 113 may provide the hash core 115 a selection of a hash algorithm to be used and a key or a nonce that is to be used for the in-line hash operation. For the in-line hash operation, the hash algorithm indicated by the CSRs 113 may be used. The hash core 115 may be equipped with logic to compute a combination of hash algorithms. In order to gain power and performance improvements, the hash algorithm may have the following features: (1) being parallel in nature in order to maintain high data bus utilization and low latency, for example, the hash algorithm may be able to sustain 8 B/cycle or 16 B/cycle operation without creating backpressure, (2) optionally supporting for keyed-hash operation, and (3) having reasonable level of security considering that key/nonce will get refreshed. A list of the hash algorithms may comprise GHASH, Keccak (SHA3), Poly1305, BLAKE3, SMS, AES-GCM, or any suitable hash algorithm. Although this disclosure describes performing an in-line hash operation on the data corresponding to the block of the local memory in a particular manner, this disclosure contemplates performing an in-line hash operation on the data corresponding to the block of the local memory in any suitable manner.

In particular embodiments, The EPU core 117 of the EPU 110 may compare an output of the in-line hash operation and a known hash for the block of the local memory 130. In particular embodiments, the EPU core 117 may determine that the output of the in-line hash operation is identical to the known hash for the block of the local memory. In response to the determination, the EPU core 117 may release a soft-reset to wake up a processing unit associated with the local memory 130. In particular embodiments, the processing unit may be a processor core. In particular embodiments, the processing unit may be a microcontroller unit (MCU). As a result, the local memory 130 may enter into ON mode when the processing unit enters into ON mode. Although this disclosure describes waking up a processing unit when the output of the in-line hash operation is identical to the known hash for the block of the local memory in a particular manner, this disclosure contemplates waking up a processing unit when the output of the in-line hash operation is identical to the known hash for the block of the local memory in any suitable manner.

In particular embodiments, the EPU core 117 may determine that the output of the in-line hash operation is not identical to the known hash for the block of the local memory 130. In response to the determination, the EPU core 117 may trigger an error interrupt request (IRQ) to a security subsystem while keep the processing unit in reset. In particular embodiments, the EPU core 117 may trigger an IRQ to the security subsystem when the local memory 130 has not reached the ON state in a pre-determined amount of time. Although this disclosure describes triggering a security subsystem when the memory integrity verification fails in a particular manner, this disclosure contemplates triggering a security subsystem when the memory integrity verification fails in any suitable manner.

In particular embodiments, the EPU core 117 may take any suitable actions in addition to triggering the security subsystem or instead of triggering the security subsystem.

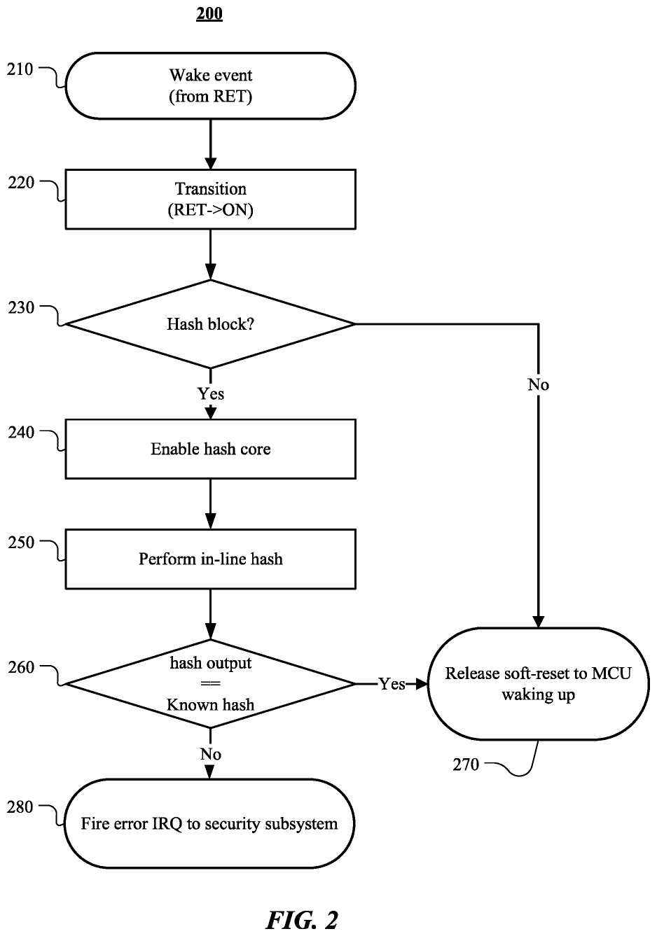

In particular embodiments, the event may cause the state of the local memory 130 from RETENTION mode into ON mode. An example of such an event may comprise receiving an interrupt request. FIG. 2 illustrates an example flow 200 for a memory integrity verification when a state of a local memory 130 changes from RETENTION mode to ON mode. At step 210, an event that wakes the local memory 130 while the local memory 130 is in RETENTION mode occurs. The event may occur when a timer sends an IRQ. The event may also occur when an attempt to access the local memory 130 happens. At step 220, the EPU core 117 may, upon detecting the event, trigger a power state transition in the FSM for the local memory 130 from RETENTION mode to ON mode. At step 230, the EPU core 117 may determine whether a hash for a block of the local memory 130 needs to be performed. If the hash is not needed, the EPU core 117 may proceed to step 270 to release a soft-reset to wake up a processing unit associated with the local memory 130. In particular embodiments, the processing unit may be an MCU. When the EPU core 117 determines that a hash is needed, the EPU core 117 may proceed to step 240, where the EPU core 117 may enable the hash core 115. Since the source location is the block of the local memory 130, the EPU core 117 may cause data from the base address of the block of the local memory to based address+size of the block to be read into the EPU 110. At step 250, the hash core 115 may perform an in-line hash operation on the data stream that flows over the interface from the subsystem NoC 120. The hash core 115 may get a key or a nonce for the in-line hash operation from the secure CSRs 113 when the data is static. The data stream may not get stored after the in-line hash operation is performed. At step 260, the EPU core 117 may compare an output of the in-line hash operation and the known hash for the block of the local memory 130. The known hash may be provided by the secure CSRs 113. When the EPU core 117 determines that the output of the in-line hash operation is identical to the known hash for the block of the local memory 130, the EPU core 117 may proceed to step 270, where the EPU core 117 may release a soft-reset to wake up a processing unit associated with the local memory 130. In particular embodiments, the processing unit may be a processor core. In particular embodiments, the processing unit may be a microcontroller unit (MCU). When the EPU core 117 determines that the output of the in-line hash operation is not identical to the known hash for the block of the local memory 130, the EPU core 117 may proceed to step 280, where the EPU core 117 may trigger an error interrupt request (IRQ) to a security subsystem while keep the processing unit in reset. Although this disclosure describes verifying memory integrity when the power state of a local memory switches from RETENTION mode into ON mode in a particular manner, this disclosure contemplates verifying memory integrity when the power state of a local memory switches from RETENTION mode into ON mode in any suitable manner.

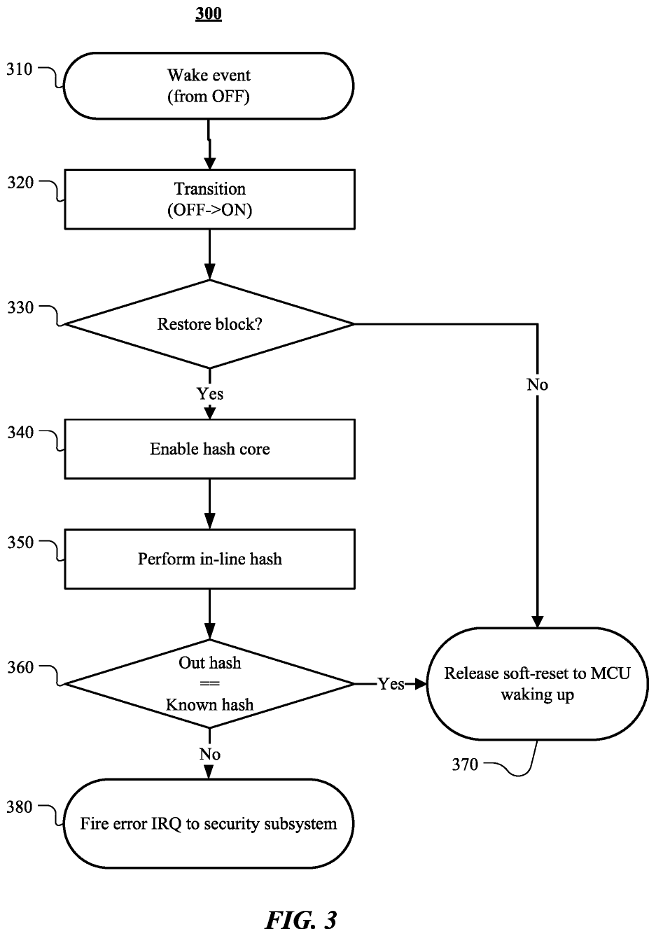

In particular embodiments, the event may cause the state of the local memory 130 from OFF mode into ON mode. The content of the local memory 130 may have been offloaded to an external memory 150 to enable power state transitions between OFF mode and ON mode with minimal latency and reduced power consumption. When the power state of the local memory 130 is switched back to ON mode, the data from the external memory 150 should be restored back to the local memory 130. While restoring the data, integrity of the data may need to be verified. Thus, data restoration process may reuse the same hardware that the previous memory integrity verification process uses. The secure CSRs 113 may contain a pointer in the external memory address space where original data can be found for the restore operation. During transition from ON mode to OFF mode, the data in the local memory 130 can be discarded (retention is not enabled) and the data may be preserved in the external memory. During a data restoration process, the EPU core 117 may perform simultaneous write-back to block destination address in the local memory 130. FIG. 3 illustrates an example flow 300 for a data restoration with an integrity verification when a state of a local memory 130 changes from OFF mode to ON mode. At step 310, an event that wakes the local memory 130 while the local memory 130 is in OFF mode occurs. At step 320, the EPU core 117 may, upon detecting the event, trigger a power state transition in the FSM for the local memory 130 from OFF mode to ON mode. At step 330, the EPU core 117 may determine whether a block of the local memory 130 needs to be restored from an external memory 150. If the data restoration is not needed, the EPU core 117 may proceed to step 370 to release a soft-reset to wake up a processing unit associated with the local memory 130. When the EPU core 117 determines that a data restoration is needed, the EPU core 117 may proceed to step 340, where the EPU core 117 may enable the hash core 115. The source location may be a location in an external memory such as a QRAM, a DRAM memory space, a memory mapped non-volatile storage device, or any suitable external memory. In particular embodiments, the source location may be a location in an always-ON region inside the computing system. The EPU core 117 may cause the data corresponding to the block of the local memory 130 to be read from the source location based on the source address for the source location and the size of the block. At step 350, the hash core 115 may perform an in-line hash operation on the data stream that flows over the interface from the subsystem NoC 120. The hash core 115 may get a key or a nonce for the in-line hash operation from the secure CSRs 113 when the data is static. The EPU core 117 may cause the data corresponding to the block of the local memory 130 to be restored into the block of the local memory after the in-line hash operation on the data is performed. At step 360, the EPU core 117 may compare an output of the in-line hash operation and the known hash for the block of the local memory 130. The known hash may be provided by the secure CSRs 113. When the EPU core 117 determines that the output of the in-line hash operation is identical to the known hash for the block of the local memory 130, the EPU core 117 may proceed to step 370, where the EPU core 117 may release a soft-reset to wake up a processing unit associated with the local memory 130. When the EPU core 117 determines that the output of the in-line hash operation is not identical to the known hash for the block of the local memory 130, the EPU core 117 may proceed to step 380, where the EPU core 117 may trigger an IRQ to a security subsystem while keep the processing unit in reset. Although this disclosure describes restoring data corresponding to a block of a local memory while verifying the integrity of the data in a particular manner, this disclosure contemplates restoring data corresponding to a block of a local memory while verifying the integrity of the data in any suitable manner.

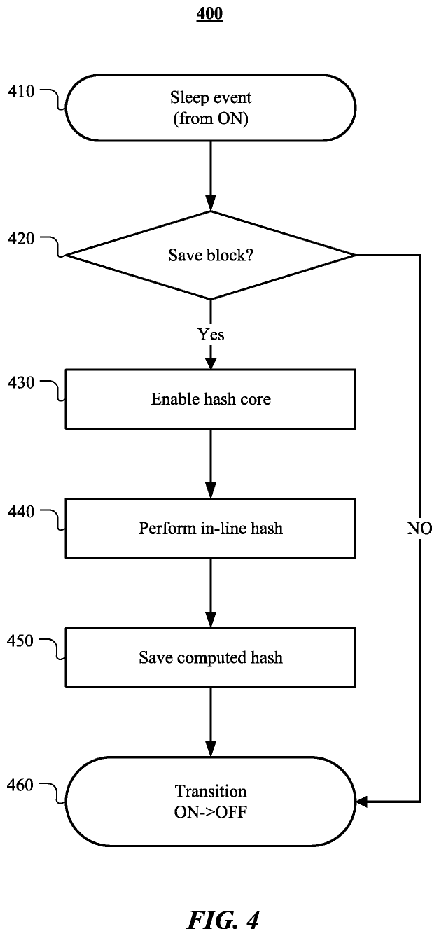

In particular embodiments, the EPU core 117 may determine that the state of the local memory needs to move into OFF mode. In particular embodiments, the EPU core 117 may detect an event that causes the power state of the local memory 130 to move into OFF mode. The EPU core 117 may cause second data to be read from a second block of the local memory 130. The second data may be dynamic data. The hash core 115 of the EPU 110 may perform a second in-line hash operation on the second data. When a nonce is used for the second in-line hash operation, Linear Feedback Shift Registers (LFSR) seeded by the ROT may generate the nonce used for the second in-line hash operation. The LFSR may generate a different nonce for every hash operation on a block of data. With that, a block of data may generate different signatures when the block of data is hashed multiple times. Different signatures may provide protection against replay attacks, where stale data is provided by an attacker from the external memory using an old nonce. The EPU core 117 may store an output of the second in-line hash operation as a known hash for the second block of the local memory. The EPU core 117 may cause the second data to be written into a second source location in an external memory. FIG. 4 illustrates an example flow 400 for dynamically offloading data corresponding to a block of a local memory 130 when a power state of the local memory 130 switches from ON mode to OFF mode. At step 410, an event that causes a local memory to switch its power state from ON mode to OFF mode occurs. On detecting the event, the EPU core 117 may determine whether offloading data corresponding to a block of the local memory 130 to an external memory is needed. When the EPU core 117 determines that offloading data is not needed, the EPU core 117 may proceed to step 460, where the EPU core 117 may switch the power state of the local memory 130 from ON mode to OFF mode in the FSM for the local memory 130. When the EPU 117 determines that the offloading is needed, the EPU core 117 may proceed to step 430, where the EPU core 117 may enable the hash core 115. The EPU core 117 may cause data corresponding to a block of the local memory 130 to be read. At step 440, the hash core 115 may perform an in-line hash on the data stream that flows over the interface from the subsystem NoC 120. The EPU core 117 may also cause the data corresponding to the block of the local memory 130 to be stored at a source location in the external memory 150 after the in-line hash operation on the data is performed. At step 450, the EPU core 117 may store an output of the in-line hash operation on the data corresponding to a second block of the local memory 130 as a known hash for the second block of the local memory 130. At step 460, the EPU core 117 may switch the power state of the local memory 130 from ON mode to OFF mode in the FSM for the local memory 130. Although this disclosure describes offloading data corresponding to a block of a local memory when a power state of the local memory switches from ON mode to OFF mode in a particular manner, this disclosure contemplates offloading data corresponding to a block of a local memory when a power state of the local memory switches from ON mode to OFF mode in any suitable manner.

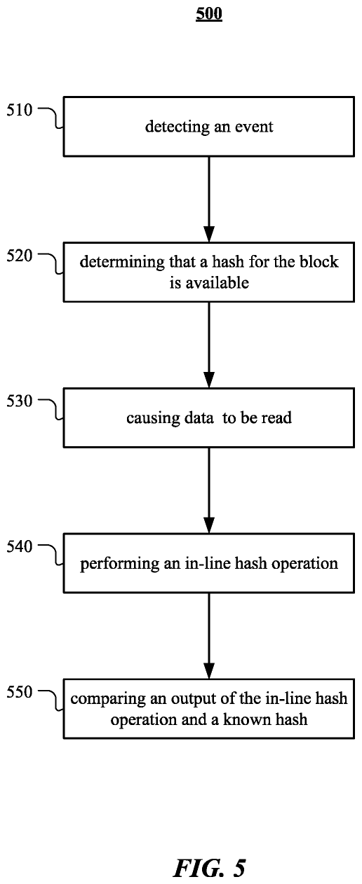

FIG. 5 illustrates an example method 500 for verifying integrity of a local memory by an EPU. The method may begin at step 510, where an EPU of a computing system may detect an event that triggers an integrity verification on a block of the local memory. At step 520, the EPU may determine that a hash for the block of the local memory is available. At step 530, the EPU may cause data corresponding to the block of the local memory to be read from a source location. At step 540, the EPU may perform an in-line hash operation on the data corresponding to the block of the local memory. At step 550, the EPU may compare an output of the in-line hash operation and a known hash for the block of the local memory. Particular embodiments may repeat one or more steps of the method of FIG. 5, where appropriate. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates an example method for verifying integrity of a local memory by an EPU including the particular steps of the method of FIG. 5, this disclosure contemplates any suitable method for verifying integrity of a local memory by an EPU including any suitable steps, which may include all, some, or none of the steps of the method of FIG. 5, where appropriate. Furthermore, although this disclosure describes and illustrates particular components, devices, or systems carrying out particular steps of the method of FIG. 5, this disclosure contemplates any suitable combination of any suitable components, devices, or systems carrying out any suitable steps of the method of FIG. 5.

### Systems and Methods

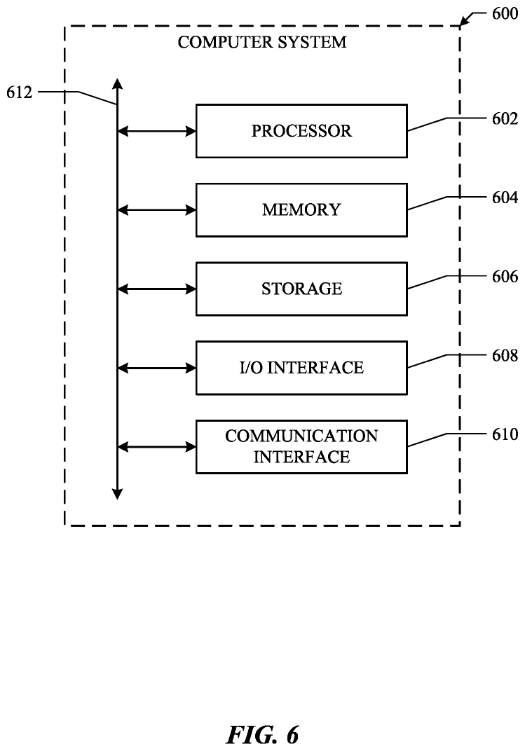

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by an Energy Processing Unit (EPU) of a computing system:
detecting an event that triggers an integrity verification on a block of the local memory;
determining that a hash for the block of the local memory is available;
causing, in response to the determination, data corresponding to the block of the local memory to be read from a source location;
performing an in-line hash operation on the data corresponding to the block of the local memory; and
comparing an output of the in-line hash operation and a known hash for the block of the local memory.

2. The method of claim 1, wherein the local memory is static random-access memory (SRAM).

3. The method of claim 1, wherein the EPU comprises Control and Status Registers (CSRs), a hash core, and an EPU core.

4. The method of claim 3, wherein the CSRs are programmed by a Root of Trust (RoT) core to maintain configuration information associated with the in-line hash operation including:
a base address of the block of the local memory and a size of the block;
a source address for the source location;
a key or a nonce to be used for the in-line hash operation;
a selection of a hash algorithm to be used;
the known hash for the block of the local memory; and
configurations that define the event.

5. The method of claim 4, wherein the CSRs provide the key or the nonce to the hash core, wherein the hash core performs the in-line hash operation with the key or the nonce.

6. The method of claim 4, wherein the CSRs provide the configuration information associated with the in-line hash operation including the known hash for the block of the local memory to the EPU core, wherein the EPU core manages Finite State Machines (FSMs) for hardware components of the computing system including the local memory.

7. The method of claim 6, wherein the EPU core releases a soft-reset to wake up a processing unit associated with the local memory when the output of the in-line hash operation is identical to the known hash for the block of the local memory.

8. The method of claim 6, wherein the EPU core triggers an error interrupt request (IRQ) to a security subsystem when the output of the in-line hash operation is not identical to the known hash for the block of the local memory.

9. The method of claim 1, wherein the event causes the state of the local memory from RETENTION mode into ON mode.

10. The method of claim 9, wherein the event comprises receiving an interrupt request.

11. The method of claim 9, wherein the source location is the block of the local memory.

12. The method of claim 1, wherein the event causes the state of the local memory from OFF mode into ON mode.

13. The method of claim 12, wherein the source location is a location in an external memory.

14. The method of claim 13, wherein the data corresponding to the block of the local memory is stored into the block of the local memory after the in-line hash operation on the data is performed.

15. The method of claim 13, further comprising:
determining whether the data corresponding to the block of the local memory needs to be restored from the location in the external memory.

16. The method of claim 12, wherein the source location is a location in an always-ON region inside the computing system.

17. The method of claim 1, further comprising:
determining that the state of the local memory needs to move into OFF mode;
cause second data to be read from a second block of the local memory;
performing a second in-line hash operation on the second data;
storing an output of the second in-line hash operation as a known hash for the second block of the local memory; and
cause the second data to be written into a second source location in an external memory.

18. The method of claim 17, wherein Linear Feedback Shift Registers (LFSR) seeded by an RoT may generate a nonce used for the second in-line hash operation to provide protections against replay attacks.

19. One or more computer-readable non-transitory storage media embodying software that is operable when executed, by an Energy Processing Unit (EPU) of a computing system, to:
detect an event that triggers an integrity verification on a block of the local memory;
determine that a hash for the block of the local memory is available;
cause, in response to the determination, data corresponding to the block of the local memory to be read from a source location;
perform an in-line hash operation on the data corresponding to the block of the local memory; and
compare an output of the in-line hash operation and a known hash for the block of the local memory.

20. A computing system comprising:
one or more processors;
an Energy Processing Unit (EPU); and
one or more computer-readable non-transitory storage media coupled to the EPU and comprising instructions operable when executed by the EPU to cause the system to:
detect an event that triggers an integrity verification on a block of the local memory;
determine that a hash for the block of the local memory is available;
cause, in response to the determination, data corresponding to the block of the local memory to be read from a source location;
perform an in-line hash operation on the data corresponding to the block of the local memory; and
compare an output of the in-line hash operation and a known hash for the block of the local memory.
